(19) United States
(12) Patent Application Publication
(10) Pub. No.: US 2012/0328889 A1
(43) Pub. Date: Dec. 27, 2012

(54) THERMALLY FOAMABLE RESIN COMPOSITION, THERMALLY FOAMABLE RESIN SHEET, THERMALLY FOAMABLE LAMINATE, AND FOAMED MATERIAL AND PROCESS FOR PRODUCTION THEREOF

(75) Inventors: Youhei Hayashi, Osaka (JP); Yoshiaki Mitsuoka, Osaka (JP); Takehiro Ul, Osaka (JP)

(73) Assignee: NITTO DENKO CORPORATION, Ibaraki-shi, Osaka (JP)

(21) Appl. No.: 13/582,716

(22) PCT Filed: Feb. 25, 2011
(86) PCT No.: PCT/JP2011/054291

§ 371 Date: Sep. 4, 2012

(30) Foreign Application Priority Data
Mar. 4, 2010 (JP) 2010-047261
Oct. 28, 2010 (JP) 2010-242014

(51) Int. Cl. C08J 9/228; B32B 27/30

(52) U.S. Cl. 428/500; 521/59

(57) ABSTRACT

A thermally foamable resin composition contains foamable resin particles and a resin composition. Each of the foamable resin particles contains a solid resin and a thermally expandable substance contained in the solid resin.

### CROSS-REFERENCE TO RELATED APPLICATIONS

The present application is a 35 U.S.C. 371 application of PCT application number PCT/JP2011/054291, filed Feb. 25, 2011, which claims priority from Japanese Patent Application Nos. 2010-047261, filed on Mar. 4, 2010, and 2010-242014, filed on Oct. 28, 2010, the contents of all of which are herein incorporated by reference in their entirety.

### TECHNICAL FIELD

The present invention relates to a thermally foamable resin composition, a thermally foamable resin sheet, a thermally foamable laminate, and a foamed material and a process for production thereof, to be specific, to a thermally foamable resin composition, a thermally foamable resin sheet, a thermally foamable laminate, and a foamed material which are used in various industrial fields and a process for production of the foamed material.

### BACKGROUND ART

Conventionally, the thermally foamable resin composition has contained a resin and a foaming agent and has been capable of foaming by generating a gas by heating. Using such a foaming, the thermally foamable resin composition has been widely used in various industrial fields.

For example, the following method has been proposed. A thermally expandable adhesive composition containing a film-formable resin, which is solid under normal temperature, and a thermally expandable capsule, is disposed between a plurality of adherends. Thereafter, it is heated and the film-formable resin is allowed to foam and cure, so that the adherends are allowed to adhere to each other (ref: for example, the following Patent Document 1).

Also, the following method has been proposed. A reinforcing agent composition containing a polyolefin and a thermally expandable microsphere is disposed on a steel plate of a bodywork. Thereafter, it is heated and the polyolefin is allowed to foam and cure, so that the steel plate is reinforced (ref: for example, the following Patent Document 2).

In the thermally foamable resin composition in Patent Documents 1 and 2 described above, the thermally expandable capsule and the thermally expandable microsphere used as the foaming agent contain a shell made of a thermoplastic resin having gas barrier properties and a low-boiling substance (a core, a thermally expandable agent) contained inside the shell.

### PRIOR ART DOCUMENT

### Patent Document

Patent Document 1: Japanese Unexamined Patent Publication No. 2007-106963
Patent Document 2: Japanese Unexamined Patent Publication No. 2004-244508

### SUMMARY OF THE INVENTION

### Problems to be Solved by the Invention

However, in the thermally foamable resin composition in the above-described Patent Documents 1 and 2, in order to allow the film-formable resin and the polyolefin to foam, it is required that by heating, the low-boiling substance (core) is thermally expanded while the shell is melted or softened. In order to sufficiently melt or soften the shell, the thermally foamable resin composition is required to be heated at high temperature.

Therefore, while a member such as the adherend and the steel plate on which the thermally foamable resin composition is disposed is required to have a sufficient heat resistance, when the member does not have a sufficient heat resistance, in view of protection of the member (for example, a plastic and the like), the thermally foamable resin composition is required to be heated at low temperature. Therefore, there is a disadvantage that a sufficient foaming of the thermally foamable resin composition and furthermore, a sufficient adhesion or reinforcement caused by such foaming cannot be achieved.

It is an object of the present invention to provide a thermally foamable resin composition, a thermally foamable resin sheet, and a thermally foamable laminate that are capable of foaming by heating at low temperature, and a foamed material and a process for production thereof.

### Solution to the Problems

A thermally foamable resin composition of the present invention contains foamable resin particles and a resin composition, and each of the foamable resin particles contains a solid resin and a thermally expandable substance contained in the solid resin.

It is preferable that the thermally foamable resin composition of the present invention can foam by heating at 120° C. or less.

In the thermally foamable resin composition of the present invention, it is preferable that the resin composition contains at least one selected from the group consisting of a rubber, a thermoplastic resin, and a thermosetting resin.

In the thermally foamable resin composition of the present invention, it is preferable that the density thereof after foaming is 0.02 to 1.5 g/cm³.

In the thermally foamable resin composition of the present invention, it is preferable that the boiling point of the thermally expandable substance is −160 to 120° C.

In the thermally foamable resin composition of the present invention, it is preferable that the foamable resin particles are obtained by polymerizing a monomer of the resin in the presence of the thermally expandable substance.

In the thermally foamable resin composition of the present invention, it is preferable that the resin is a polystyrene and/or a polystyrene copolymer.

In the thermally foamable resin composition of the present invention, it is preferable that the content ratio of the foamable resin particles is 0.1 to 350 parts by weight with respect to 100 parts by weight of the resin composition.

A thermally foamable resin sheet of the present invention is formed from the above-described thermally foamable resin composition into a sheet shape.

A thermally foamable laminate of the present invention includes a heat generating member capable of generating heat and the above-described thermally foamable resin sheet laminated so as to be in contact with the heat generating member.

In the thermally foamable laminate of the present invention, it is preferable that the heat generating member generates heat by an electric conduction.

In the thermally foamable laminate of the present invention, it is preferable that the heat generating member generates heat by microwave irradiation.

A foamed material of the present invention is obtained by heating the above-described thermally foamable resin composition to foam.

A foamed material of the present invention is obtained by heating the above-described thermally foamable resin sheet to foam.

It is preferable that the foamed material of the present invention is obtained by allowing the heat generating member of the above-described thermally foamable laminate to generate heat so as to heat the thermally foamable resin sheet to foam.

A foamed material of the present invention is obtained by conducting electricity through the heat generating member of the above-described thermally foamable laminate to allow the heat generating member to generate heat so as to heat the thermally foamable sheet to foam.

A foamed material of the present invention is obtained by applying a microwave to the heat generating member of the above-described thermally foamable laminate to allow the heat generating member to generate heat so as to heat the thermally foamable sheet to foam.

A method for producing a foamed material of the present invention includes heating the above-described thermally foamable resin composition to foam.

A method for producing a foamed material of the present invention includes heating the above-described thermally foamable resin sheet to foam.

A method for producing a foamed material of the present invention includes allowing the heat generating member of the above-described thermally foamable laminate to generate heat so as to heat the thermally foamable resin sheet to foam.

A method for producing a foamed material of the present invention includes conducting electricity through the heat generating member of the above-described thermally foamable laminate to allow the heat generating member to generate heat so as to heat the thermally foamable resin sheet to foam.

A method for producing a foamed material of the present invention includes applying a microwave to the heat generating member of the above-described thermally foamable laminate to allow the heat generating member to generate heat so as to heat the thermally foamable resin sheet to foam.

In the method for producing the foamed material of the present invention, it is preferable that the thermally foamable resin composition or sheet is heated at a temperature of 120° C. or less.

### Effect of the Invention

According to the thermally foamable resin composition and the thermally foamable resin sheet of the present invention, each of the foamable resin particles contains the solid resin in which the thermally expandable substance is contained, so that the thermally expandable substance can be allowed to expand even by heating at low temperature.

Therefore, in the producing method of the foamed material of the present invention, the resin composition can be allowed to surely foam even by heating at low temperature.

As a result, the thermally foamable resin sheet formed of the thermally foamable resin composition of the present invention and the thermally foamable laminate including the thermally foamable resin sheet can be used in various industrial fields requiring heating at low temperature.

### BRIEF DESCRIPTION OF THE DRAWINGS

FIG. 1 shows sectional views for illustrating one embodiment of a producing method of a foamed material of the present invention:

(a) illustrating a step of disposing a thermally foamable resin sheet in the internal space of a hollow member and

(b) illustrating a step of allowing the thermally foamable resin sheet to foam by heating.

FIG. 2 shows sectional views for illustrating another embodiment (an embodiment of allowing a heat generating member to generate heat by an electric conduction) of the producing method of the foamed material of the present invention:

(a) illustrating a step of disposing a thermally foamable laminate including the heat generating member (an embodiment of including a heat generating portion, an insulator, and a metal exterior plate) and the thermally foamable resin sheet laminated thereon in the internal space of the hollow member and

(b) illustrating a step of conducting electricity through the heat generating member for allowing the heat generating member to generate heat, causing the thermally foamable resin sheet to foam by heating.

FIG. 3 shows sectional views for illustrating another embodiment (an embodiment of allowing the heat generating member to generate heat by the electric conduction) of the producing method of the foamed material of the present invention:

(a) illustrating a step of disposing the thermally foamable laminate including the heat generating member (an embodiment of including the heat generating portion) and the thermally foamable resin sheet laminated thereon in the internal space of the hollow member and

(b) illustrating a step of conducting electricity through the heat generating member for allowing the heat generating member to generate heat, causing the thermally foamable resin sheet to foam by heating.

FIG. 4 shows sectional views for illustrating another embodiment (an embodiment of allowing the heat generating member to generate heat by microwave irradiation) of the producing method of the foamed material of the present invention:

(a) illustrating a step of disposing the thermally foamable laminate including the heat generating member (an embodiment of including a microwave absorber) and the thermally foamable resin sheet laminated thereon in the internal space of the hollow member and

(b) illustrating a step of applying a microwave to the heat generating member for allowing the heat generating member to generate heat, causing the thermally foamable resin sheet to foam by heating.

FIG. 5 shows schematic explanatory views of an evaluation method of foamable filling properties in Examples:

(a) illustrating a step of disposing the thermally foamable resin sheet made of a thermally foamable resin composition between test steel plates and

(b) illustrating a step of allowing the thermally foamable resin sheet to foam by heating.

### EMBODIMENT OF THE INVENTION

A thermally foamable resin composition of the present invention contains thermally foamable resin particles and a resin composition.

In the thermally foamable resin composition of the present invention, each of the foamable resin particles contains a solid resin and a thermally expandable substance contained (impregnated) in the solid resin.

An example of the resin includes a resin, which is capable of uniformly containing the thermally expandable substance and furthermore, is difficult to be curd by heating. Preferably, a thermoplastic resin is used.

The thermoplastic resin contains a thermoplastic elastomer. Examples thereof include a styrene resin, polyolefin, an acrylic resin, polyvinyl acetate, an ethylene-vinyl acetate copolymer (EVA), polyvinyl chloride, polyacrylonitrile, polyamide (PA, nylon), polycarbonate, polyacetal, polyethylene terephthalate (PET), polyphenylene oxide, polyphenylene sulfide, polysulfone, polyether sulfone, poly ether ether ketone (PEEK), polyallyl sulfone, a thermoplastic polyimide resin, a thermoplastic urethane resin, a polyamino-bismaleimide resin, a polyamide-imide resin, a polyether-imide resin, a bismaleimide-triazine resin, a polymethylpentene, a fluorine resin, a liquid crystal polymer, an olefin-vinyl alcohol copolymer, ionomer, and polyarylate.

These thermoplastic resins can be used alone or in combination of two or more.

Of the thermoplastic resins, preferably, a styrene resin and an acrylic resin are used.

An example of the styrene resin includes a styrene polymer (a styrene homopolymer) obtained by polymerizing a monomer containing a styrene monomer. An example of the styrene monomer includes styrene and styrene derivatives such as α-methylstyrene, ring-halogenated styrene, ring-alkylated styrene, 2-vinyltoluene (o-methylstyrene), 3-vinyltoluene (m-methylstyrene), and 4-vinyltoluene (p-methylstyrene). These styrene monomers can be used alone or in combination of two or more. As the styrene monomer, preferably, styrene is used.

As the styrene polymer, preferably, polystyrene (polystyrene homopolymer) is used.

An example of the styrene resin includes a styrene copolymer (a polystyrene copolymer) of the above-described styrene monomer and a copolymerizable monomer which is copolymerizable with the styrene monomer. Examples of the copolymerizable monomer include an ester (that is, (meth)acrylate) of (meth)acrylate (acrylic acid and/or methacrylic acid) and an alcohol having 1 to 8 carbon atoms, dimethyl fumarate, (meth)acrylonitrile, vinyl cyanide, ethylene, butadiene, divinylbenzene, and alkylene glycol dimethacrylate. These copolymerizable monomers can be used alone or in combination of two or more. As the copolymerizable monomer, preferably, (meth)acrylate, acrylonitrile, ethylene, and butadiene are used.

As the styrene copolymer, preferably, a (meth)acrylate-styrene copolymer (that is, a methyl methacrylate-styrene copolymer (MS) and/or a methyl acrylate-styrene copolymer), an acrylonitrile-ethylene-styrene copolymer (AES), an acrylonitrile-styrene copolymer (AS), and an acrylonitrile-butadiene-styrene copolymer (ABS) are used, or more preferably, MS and AS are used.

MS is a block or random copolymer of methyl (meth)acrylate and styrene, and the content of the methyl (meth)acrylate is, for example, 10 to 60 weight %.

AS is a block or random copolymer of acrylonitrile and styrene, and the content of the acrylonitrile is, for example, 10 to 60 weight %.

Examples of the acrylic resin include polymethyl (meth)acrylate (that is, polymethyl acrylate and/or polymethyl methacrylate), polyethyl (meth)acrylate, and polypropyl (meth)acrylate.

The resin is formed into a solid shape (that is, not hollow) and the density thereof is, for example, 0.9 to 2.0 g/cm³, or preferably 1.0 to 1.5 g/cm³.

The glass transition temperature of the resin is, for example, 50 to 110° C., or preferably 80 to 90° C.

The thermally expandable substance is a substance which expands by heating and to be specific, is a substance which expands, that is, gasifies (vaporizes or boils) at a specific temperature to be described later. Examples thereof include a hydrocarbon, a halogenated hydrocarbon, and a non-inflammable gas.

Examples of the hydrocarbon include a saturated hydrocarbon and an unsaturated hydrocarbon. Preferably, a saturated hydrocarbon is used.

Examples of the saturated hydrocarbon include a straight chain alkane, a branched chain alkane, and a cycloalkane.

An example of the straight chain alkane includes a straight chain alkane having 1 to 7 carbon atoms (an aliphatic hydrocarbon) such as methane, ethane, propane, butane, pentane, hexane, and heptane.

An example of the branched chain alkane includes a branched chain alkane having 4 to 7 carbon atoms such as 2-methylpropane (isobutane), 2-methylbutane (isopentane), 2,2-dimethylpropane (neopentane), 2-methylpentane, 3-methylpentane, 2,3-dimethylbutane, and 2,4-dimethylpentane.

An example of the cycloalkane includes a cycloalkane having 3 to 7 carbon atoms such as cyclopropane, cyclobutane, cyclopentane, cyclohexane, and cycloheptane.

As the saturated hydrocarbon, preferably, a straight chain alkane is used.

Examples of the halogenated hydrocarbon includes a chlorohydrocarbon such as dichloromethane (CCl₂H₂); a fluorohydrocarbon such as difluoromethane (CF₂H₂); and a chlorofluorohydrocarbon such as Freon 22 (trademark, CHClF₂), Freon 12 (trademark, CCl₂F₂), and Freon 113 (trademark, CCl₂FCClF₂).

An example of the non-inflammable gas includes carbon dioxide.

Of the thermally expandable substances, preferably, a hydrocarbon is used.

The boiling point of the thermally expandable substance is, for example, −160 to 120° C., preferably −50 to 100° C., or more preferably −5 to 70° C.

When the boiling point of the thermally expandable substance exceeds the above-described range, the foaming of the thermally foamable resin composition at low temperature may be difficult. When the boiling point of the thermally expandable substance is below the above-described range, it may be difficult to allow the resin to uniformly contain the thermally expandable substance.

The foamable resin particles can be obtained by polymerizing the monomer of the resin described above in the presence of a solvent and the thermally expandable substance. Alternatively, the foamable resin particles can be obtained by polymerizing the monomer of the resin described above in the absence of the solvent and in the presence of the thermally expandable substance.

Preferably, the monomer of the resin is polymerized in the presence of the solvent and the thermally expandable substance.

Examples of the solvent include an aqueous solvent such as water and an organic solvent such as toluene. Preferably, an aqueous solvent is used.

To be specific, the foamable resin particles are obtained by allowing the monomer to be aqueous-dispersed and suspension-polymerized in the aqueous solvent into which a dispersant is blended and the thermally expandable substance is blown (flowed). According to the above-described polymerization method, the thermally expandable substance can be uniformly contained in the resin.

The foamable resin particle obtained in this way is formed into a solid sphere shape (a bead shape) or a solid pellet shape. Preferably, the foamable resin particle is formed into a solid bead shape.

The average particle size of the foamable resin particle is, for example, 0.10 to 4.0 mm, or preferably 0.15 to 2.0 mm. The average particle size of the foamable resin particle can be also set to be, for example, 0.2 to 4.0 mm, or preferably 0.4 to 1.0 mm.

When the average particle size of the foamable resin particle exceeds the above-described range, the design, and the uniformity of foamability thereof may be reduced. When the average particle size of the foamable resin particle is below the above-described range, the thermally expandable substance easily volatilizes and the storage stability thereof may be damaged.

In the foamable resin particle, the thermally expandable substance is contained in the solid resin.

That is, in the foamable resin particle, the thermally expandable substance penetrates from the outside surface of the resin, which is solid (not hollow) and in a particle shape, into the inside thereof.

The content ratio of the thermally expandable substance is, for example, 1 to 10 parts by weight, or preferably 2 to 8 parts by weight with respect to 100 parts by weight of the resin.

In this way, in the foamable resin particles, the thermal expansion starts at a temperature (a thermal expansion starting temperature) of low temperature, to be specific, at, for example, 120° C. or less (to be specific, 70 to 120° C.), 110° C. or less (to be specific, 70 to 110° C.), or furthermore 100° C. or less (to be specific, 70 to 120° C.).

The density of the foamable resin particle after the thermal expansion is, for example, 0.005 to 0.5 g/cm³, or preferably 0.01 to 0.1 g/cm³.

The thermal expansion ratio of the foamable resin particles at 100° C. is, though depending on the content proportion of the thermally expandable substance, for example, 2 to 200 times, or preferably 10 to 100 times.

A commercially available product (a foamable bead) can be used as the foamable resin. Examples thereof include “STYRODIA” (a foamable polystyrene bead), “HEATPOR” (a foamable acrylonitrile-styrene copolymer bead), and “CLEARPOR” (a foamable methylmethacrylate-styrene copolymer bead) (the above are manufactured by JSP); “Eslen Beads” (a foamable polystyrene bead) and “PN beads” (a special foamable polystyrene bead) (the above are manufactured by SEKISUI PLASTICS CO., LTD.); and “KANEPEARL” (a foamable polystyrene bead or a foamable polymethylmethacrylate bead, manufactured by Kaneka Corporation).

In the thermally foamable resin composition of the present invention, the resin composition contains, for example, a rubber, a thermoplastic resin, and a curable resin.

The rubber is not particularly limited and examples thereof include a synthetic rubber such as a polyisobutylene rubber (PIB), a chloroprene rubber (CR), a butyl rubber (BR), an ethylene-propylene rubber (EPM), an ethylene-propylene-diene rubber (EPDM), a styrene rubber, a nitrile rubber, an urethane rubber, a polyamide rubber, a silicone rubber, a polyether rubber, and a polysulfide rubber and a natural rubber.

The rubbers can be used alone or in combination of two or more.

Of the rubbers, preferably, a synthetic rubber is used, or more preferably, PIB, EPDM, and a silicone rubber are used.

PIB is a synthetic rubber obtained by polymerization of isobutylene (isobutene).

EPDM is a synthetic rubber obtained by copolymerization of ethylene, propylene, and dienes. To be specific, EPDM is obtained by further copolymerizing the dienes with the ethylene-propylene copolymer (EPM).

Examples of the dienes include 5-ethylidene-2-norbornene, 1,4-hexadiene, and dicyclopentadiene.

The content of the diene in EPDM is, for example, 1 to 20 weight %, or preferably 3 to 10 weight %.

The silicone rubber is a synthetic rubber containing an organic group such as an alkyl group, and/or an aryl group, and the like in polysiloxane ((—Si—O—)ₙ).

The Mooney viscosity of the rubber at 100° C. is, for example, 0.5 to 150 ML₁₊₄, or preferably 1 to 100 ML₁₊₄.

The weight average molecular weight (GPC: calibrated with standard polystyrene) of the rubber is, for example, 1000 to 1000000, or preferably 10000 to 100000.

The density of the rubber is, for example, 0.8 to 2.1 g/cm³, or preferably 0.85 to 2.0 g/cm³.

An example of the thermoplastic resin includes the same thermoplastic resin as that used in the resin of the foamable resin particles described above. The thermoplastic resins can be used alone or in combination.

The thermosetting resin is not particularly limited and examples thereof include an epoxy resin, a polyimide resin (a thermosetting polyimide resin), a phenol resin, a urea resin, a melamine resin, an unsaturated polyester resin, a diallyl phthalate resin, a silicone resin, and an urethane resin (a thermosetting urethane resin).

The thermosetting resins can be used alone or in combination of two or more.

As the thermosetting resin, preferably, an epoxy resin is used.

Examples of the epoxy resin include an aromatic epoxy resin such as a bisphenol epoxy resin (for example, a bisphenol A epoxy resin, a bisphenol F epoxy resin, a bisphenol S epoxy resin, a hydrogenated bisphenol A epoxy resin, a dimer acid-modified bisphenol epoxy resin, and the like), a novolak epoxy resin (for example, a phenol novolak epoxy resin, a cresol novolak epoxy resin, a biphenyl epoxy resin, and the like), and a naphthalene epoxy resin; a nitrogen-containing-cyclic epoxy resin such as triepoxypropyl isocyanurate (triglycidyl isocyanurate) and a hydantoin epoxy resin; an aliphatic epoxy resin; an alicyclic epoxy resin (for example, a dicyclo epoxy resin and the like); a glycidylether epoxy resin; and a glycidylamine epoxy resin.

These epoxy resins can be used alone or in combination of two or more.

As the epoxy resin, preferably, a bisphenol epoxy resin is used.

The epoxy resin has an epoxy equivalent of, for example, 50 to 20000 g/eqiv., or preferably 100 to 5000 g/eqiv.

The weight average molecular weight (GPC: calibrated with standard polystyrene) or the molecular weight of the thermosetting resin (before curing) is, for example, 200 to 3000000, or preferably 300 to 2000000.

The density of the thermosetting resin is, for example, 1.0 to 1.5 g/cm³, or preferably 1.1 to 1.4 g/cm³.

The above-described components (the rubber, the thermoplastic resin, and the thermosetting resin) can be used alone or in combination of two or more.

When the rubber, the thermoplastic resin, and the thermosetting resin are respectively used alone, the mixing ratio of each of the components is, for example, 100 parts by weight or less, or preferably 90 parts by weight or less with respect to 100 parts by weight of the resin composition.

When the rubber, the thermoplastic resin, and the thermosetting resin are used in combination, the mixing ratio of each of the components is, for example, 80 parts by weight or less, or preferably 1 to 50 parts by weight with respect to 100 parts by weight of the resin composition.

In the thermally foamable resin composition, the mixing ratio of the foamable resin particles is, for example, 0.1 to 350 parts by weight, or preferably 5 to 320 parts by weight with respect to 100 parts by weight of the resin composition. The mixing ratio of the foamable resin particles can be also set to be, for example, 0.1 to 130 parts by weight, or preferably 50 to 100 parts by weight with respect to 100 parts by weight of the resin composition.

When the mixing ratio of the foamable resin particles is below the above-described range, there may be a case where the foaming ratio becomes significantly low, so that the resin composition cannot be allowed to sufficiently foam. On the other hand, when the mixing ratio of the foamable resin particles exceeds the above-described range, the foamable resin particles may fall off from the resin composition.

A known additive can be also added to the resin composition at an appropriate ratio as long as it does not inhibit the effect of the present invention. Examples thereof include fillers, curing agents, cross-linking agents, vulcanizing agents, and other foaming agents (foaming agents excluding foamable resin particles) and furthermore, foaming accelerators, curing accelerators, cross-linking accelerators, vulcanization accelerators, thixotropic agents, lubricants, pigments, antiscorching agents, stabilizers, softeners, plasticizers, oxidation inhibitors, antioxidants, ultraviolet absorbers, colorants, fungicides, flame retardants, and tackifiers.

Examples of the filler include talc, calcium carbonate, carbon black, titanium oxide, silica, aluminum hydroxide (alumina), magnesium hydroxide, and barium sulfate (barite). These fillers can be used alone or in combination. The mixing ratio of the filler is, for example, less than 1000 parts by weight, in view of weight, preferably 10 to 700 parts by weight, or more preferably 20 to 500 parts by weight with respect to 100 parts by weight of the resin composition. The mixing ratio of the filler can be also set to be, for example, less than 100 parts by weight, preferably 10 to 70 parts by weight, or more preferably 20 to 50 parts by weight with respect to 100 parts by weight of the resin composition.

An example of the curing agent includes a heat curing type curing agent which is cured by heating. To be specific, examples thereof include amine compounds, acid anhydride compounds, amide compounds, hydrazide compounds, imidazole compounds, and imidazoline compounds. Other than those, examples thereof include phenol compounds, urea compounds, and poly sulfide compounds.

Examples of the amine compounds include ethylene diamine, propylene diamine, diethylene triamine, triethylene tetramine, and amine adducts thereof; metha phenylenediamine; diaminodiphenyl methane; and diaminodiphenyl sulfone.

Examples of the acid anhydride compounds include phthalic anhydride, maleic anhydride, tetrahydrophthalic anhydride, hexahydrophthalic anhydride, methyl nadic anhydride, pyromelletic anhydride, dodecenylsuccinic anhydride, dichloro succinic anhydride, benzophenone tetracarboxylic anhydride, and chlorendic anhydride.

Examples of the amide compounds include dicyandiamide and polyamide.

An example of the hydrazide compounds includes dihydrazide such as adipic acid dihydrazide.

Examples of the imidazole compounds include methyl imidazole, 2-ethyl-4-methyl imidazole, ethyl imidazole, isopropyl imidazole, 2,4-dimethyl imidazole, phenyl imidazole, undecyl imidazole, heptadecyl imidazole, and 2-phenyl-4-methyl imidazole.

Examples of the imidazoline compounds include methylimidazoline, 2-ethyl-4-methylimidazoline, ethylimidazoline, isopropylimidazoline, 2,4-dimethylimidazoline, phenylimidazoline, undecylimidazoline, heptadecylimidazoline, and 2-phenyl-4-methylimidazoline.

These curing agents can be used alone or in combination. The mixing ratio of the curing agent is, though depending on the equivalent ratio of the curing agent to the resin composition (preferably, the thermosetting resin), for example, 0.5 to 50 parts by weight, or preferably 1 to 40 parts by weight with respect to 100 parts by weight of the resin composition.

An example of the cross-linking agent includes a radical generator which generates a free radical due to the decomposition thereof by heating to produce a cross-linking bond between molecules or in a molecule. To be more specific, an example thereof includes an organic peroxide such as dicumyl peroxide (DCP), 1,1-di-tert-butyl peroxy-3,3,5-trimethylcyclohexane, 2,5-dimethyl-2,5-di-tert-butyl peroxyhexane, 2,5-dimethyl-2,5-di-tert-butyl peroxyhexyne, 1,3-bis(t-butylperoxyisopropyl)benzene, tert-butylperoxyketone, and tert-butylperoxybenzoate. The cross-linking agents can be used alone or in combination. The mixing ratio of the cross-linking agent is, for example, 0.1 to 10 parts by weight, or preferably 0.5 to 7 parts by weight with respect to 100 parts by weight of the resin composition.

Examples of the vulcanizing agent include sulfur, sulfur compounds, selenium, magnesium oxide, lead monoxide, zinc oxide, polyamines, oximes, nitroso compounds, resins, and ammonium salts. The vulcanizing agents can be used alone or in combination. The mixing ratio thereof is, for example, 0.1 to 10 parts by weight, or preferably 0.5 to 3 parts by weight with respect to 100 parts by weight of the resin composition.

Examples of the other foaming agents include an inorganic foaming agent and an organic foaming agent. Examples of the inorganic foaming agent include sodium bicarbonate, sodium carbonate, ammonium bicarbonate, ammonium carbonate, and ammonium nitrite.

Examples of the organic foaming agent include an azo compound such as azodicarbonamide (ADCA), azobisisobutyronitrile (AIBN), azocyclohexylnitrile, azodiaminobenzene, and barium azodicarboxylate; a nitroso compound such as N,N′-dinitrosopentamethylenetetramine (DPT) and N,N′-dimethyl-N,N′-dinitrosoterephthalamide; a sulfonyl hydrazide compound such as benzenesulfonyl hydrazide, toluenesulfonyl hydrazide, p,p′-oxybis(benzenesulfonyl hydrazide) (OBSH), diphenylsulfone-3,3′-disulfonyl hydrazide and 4,4′-oxsobisbenzenesulfonyl hydrazide; and an azide compound such as p-toluenesulfonyl azide.

The other foaming agents can be used alone or in combination of two or more. The mixing ratio thereof is, for example, 100 parts by weight or less, or preferably 50 parts by weight or less, and usually is 5 parts by weight or more with respect to 100 parts by weight of the foamable resin particles.

The thermally foamable resin composition is, for example, prepared by simultaneously blending each of the components of the resin composition described above with the foamable resin particles.

To be specific, the above-described rubber, thermoplastic resin, and curable resin, and the additive added thereto as required are kneaded with the foamable resin particles with, for example, a mixing roll, a pressurized kneader, an extruder, or the like, so that the thermally foamable resin composition is prepared as a kneaded product.

In the kneading, the resin composition and the foamable resin particles are heated at, for example, a temperature less than the thermal expansion starting temperature of the foamable resin particles, to be specific, a temperature of normal temperature (20° C.) to less than 70° C., or preferably a temperature of 20 to 55° C.

Alternatively, first, the above-described rubber, thermoplastic resin, and curable resin, and the additive added thereto as required are blended to prepare the resin composition. Thereafter, the foamable resin particles are blended into the resin composition, so that the thermally foamable resin composition can be prepared.

To be specific, first, the above-described rubber, thermoplastic resin, and curable resin, and the additive added thereto as required are kneaded in the same manner as in the description above to prepare the resin composition. In the kneading, the resin composition is heated at a temperature of, for example, 70 to 120° C., or preferably a temperature of 80 to 110° C.

The Mooney viscosity of the resin composition at 100° C. is, for example, 0.5 to 150 (ML₁₊₄), or preferably 1 to 100 (ML₁₊₄).

Thereafter, the resin composition is cooled to a temperature of normal temperature (20° C.) to less than 70° C., or preferably a temperature of 20 to 55° C. Subsequently, the foamable resin particles are blended into the resin composition.

To be specific, the resin composition and the foamable resin particles are kneaded in the same manner as in the description above, so that the thermally foamable resin composition as a kneaded product is prepared.

In the kneading, the resin composition and the foamable resin composition are heated at, for example, a temperature less than the thermal expansion starting temperature of the foamable resin particles, to be specific, a temperature of normal temperature (20° C.) to less than 70° C., or preferably a temperature of 20 to 55° C.

Thereafter, the prepared kneaded product (the thermally foamable resin composition) is formed into a predetermined shape such as a sheet shape by, for example, a molding method such as a calendar molding, an extrusion molding, an injection molding, a press molding, or the like as required.

In the molding of the kneaded product, the kneaded product is heated at, for example, a temperature less than the thermal expansion starting temperature of the foamable resin particles, to be specific, a temperature of normal temperature (20° C.) to less than 70° C., or preferably a temperature of 20 to 55° C.

When the kneaded product is formed into a sheet shape, the thickness of the sheet is, for example, 0.1 to 10 mm.

In this way, the thermally foamable resin composition can be obtained as a sheet. That is, the thermally foamable resin sheet can be obtained.

According to the thermally foamable resin composition of the present invention, each of the foamable resin particles is formed in such a way that the thermally expandable substance is contained in the resin, so that the thermally expandable substance can be allowed to uniformly expand in the resin even by heating at low temperature.

Therefore, the resin composition can be allowed to surely foam even by heating at low temperature.

That is, the thermally foamable resin composition can foam at, for example, a temperature of 120° C. or less (to be specific, 70 to 120° C.). In addition, the thermally foamable resin composition may foam at a temperature of 110° C. or less (to be specific, 70 to 110° C.) and furthermore, foam at a temperature of 100° C. or less (to be specific, 70 to 100° C.).

The thermally foamable resin composition can be allowed to foam by being heated at the above-described desired temperature (low temperature).

As a result, the thermally foamable resin composition of the present invention can be used in various industrial fields requiring the heating at low temperature, including a case where a member (for example, a resin molded product made of the thermoplastic resin (plastic)) in which the thermally foamable resin composition is disposed is damaged or deteriorated in a case of exceeding the above-described foaming temperature.

For example, the foamed material obtained by allowing the above-described thermally foamable resin composition to foam can be used as a filler of industrial products in various industrial fields. The filler is used to fill in space between various members or the internal space of a hallow member.

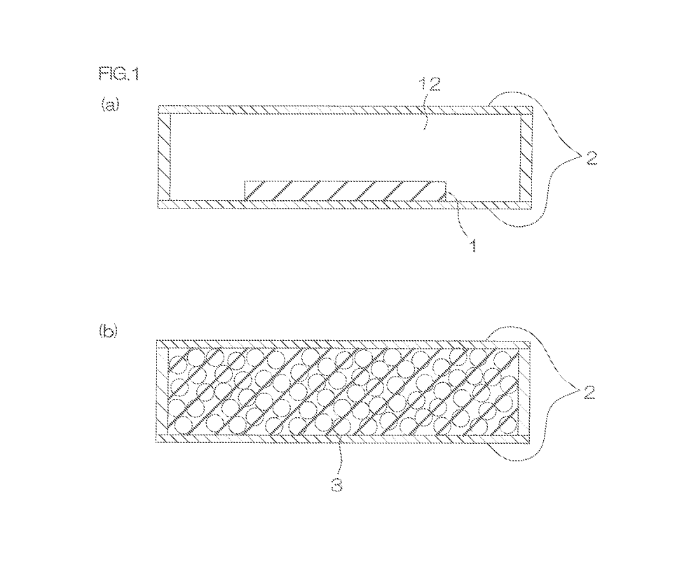

FIG. 1 shows sectional views for illustrating one embodiment of a producing method of a foamed material of the present invention.

Next, a method of filling the foamed material in the internal space of the hollow member is described with reference to FIG. 1.

In FIG. 1, in order to fill a foamed material 3 in internal space 12 of a hollow member 2, for example, a thermally foamable resin sheet 1 made of the thermally foamable resin composition is disposed in the internal space 12 of the hollow member 2. The thermally foamable resin sheet 1 is disposed so as to be in contact with the inner surface of the hollow member 2.

Thereafter, the disposed thermally foamable resin sheet 1 is heated with the above-described hollow member 2 to allow the thermally foamable resin sheet 1 to foam, so that the foamed material 3 is formed. In this way, the internal space 12 of the hollow member 2 is filled in by the formed foamed material 3.

The heating method of the thermally foamable resin sheet 1 is not particularly limited. Examples thereof are as follows: a method of allowing the hollow member 2 on which the thermally foamable resin sheet 1 is disposed to stand (be stored) under hot air atmosphere (air) of a dryer (for example, an oven such as a hot air dryer), a method of immersing the above-described hollow member 2 in heated liquid (a heating medium), a method of applying far-infrared rays to the above-described hollow member 2, and a method of using a reaction heat of a chemical reaction.

The foamed material 3 can be filled in space between the above-described various members in the same manner as in the above-described method of filling the foamed material 3 in the internal space 12 of the hollow member 2.

The above-described filler can impart various effects to the above-described member or hollow member. Examples of the effect include reinforcement, vibration damping (vibration proofing), sound proofing, dust proofing, heat insulation, buffering, watertight and air tight, or adhesion. Therefore, the foamed material 3 can be preferably used as a filler of various industrial products, which fills in space between various members or the internal space of the hollow member. Examples thereof include a reinforcing material, a vibration damping material (a vibration proofing material), a sound proofing material, a dust proofing material, a heat insulating material, a buffer material, a waterproofing material, or an adhesive material.

Among all, the thermally foamable resin composition of the present invention is used in seals for automobiles, electric appliances, and housing products. In such a case, the thermally foamable resin sheet formed of the foamable resin composition is fixed in space of an automobile, an electric appliance, or a housing product and is then allowed to foam. In this way, the space is filled in with the foamed material. That is, the thermally foamable resin sheet, preferably as a sealing material for the exterior of automobiles, a sealing material for electric appliances, a sealing material for housing products, or the like, is used as a sealing material for sealing space of various members such as automobiles, electric applicanes, and housing products. The foamed material can be used for vibration proofing, sound proofing, dust proofing, heat insulation, buffering, watertight and air tight as a vibration proofing material, a sound proofing material, a dust proofing material, a heat insulating material, a buffer material, a waterproofing material, and the like of automobiles, electric appliances, or housing products.

The thermally foamable resin composition of the present invention is, for example, used in the hollow member of the automobile, to be specific, in vibration damping, heat insulation, sound proofing, and reinforcement of a pillar. In such a case, a sheet (a thermally foamable resin sheet) formed of the thermally foamable resin composition is fixed in the internal space of the pillar and is then allowed to foam by heating. Then, the internal space of the pillar is filled in with the foamed material. In this way, the reinforcement of the pillar can be achieved, while the vibration and/or noise of an engine and furthermore, wind noise are prevented from transferring into the inside of the automobile.

In addition, the thermally foamable resin composition of the present invention can be used in, for example, reinforcement of a structural member of the automobile, to be specific, a steel plate of bodywork, a bumper, an instrument panel, and the like. In such a case, first, a steel plate reinforcing sheet is produced by laminating a constraining layer formed of a glass cloth or the like on a sheet (the thermally foamable resin sheet) formed of the thermally foamable resin composition. Next, the thermally foamable resin sheet of the produced steel plate reinforcing sheet is attached to the above-described structural member of the automobile and is then allowed to foam by heating. In this way, the structural member of the automobile can be reinforced by the steel plate reinforcing sheet including the foamed material.

On the other hand, when the thermally expandable capsule in the above-described Patent Document 1 is kneaded to prepare the thermally foamable resin composition as a kneaded product, the shearing force (shear) is applied to the thermally expandable capsule at the time of kneading, so that the shell is damaged and the core easily flows out. As a result, even when the kneaded product is heated, it may be difficult to allow the resin to foam.

However, the foamable resin particles of the present invention do not have the core-shell structure as that in the above-described Patent document 1 and have a structure of containing the thermally expandable substance in the solid resin. Therefore, even when the shearing force (shear) is applied to the foamable resin particles at the time of kneading, the thermally expandable substance can be prevented from flowing out.

Thus, when the kneaded product is heated, the resin composition can be allowed to surely foam.

The density of the foamed material obtained in this way is, for example, 0.02 to 1.5 g/cm³, preferably 0.05 to 1.3 g/cm³, or more preferably 0.06 to 0.2 g/cm³. The density of the foamed material can be also set to be, for example, 0.03 to 1.0 g/cm³, or preferably 0.05 to 0.5 g/cm³. The density of the foamed material is measured in conformity with JIS Z8807.

When the density of the foamed material is outside the above-described range, the filling properties of the foamed material may be reduced.

The foaming ratio (that is, the volume expansion ratio of the thermally foamable resin composition at the time of foaming) is, for example, 2 to 30 times, preferably 2 to 20 times, or more preferably 5 to 16 times.

The foaming ratio is calculated as the density of the thermally foamable resin composition (the thermally foamable resin composition before foaming/the density of the foamed material (the thermally foamable resin composition after foaming.

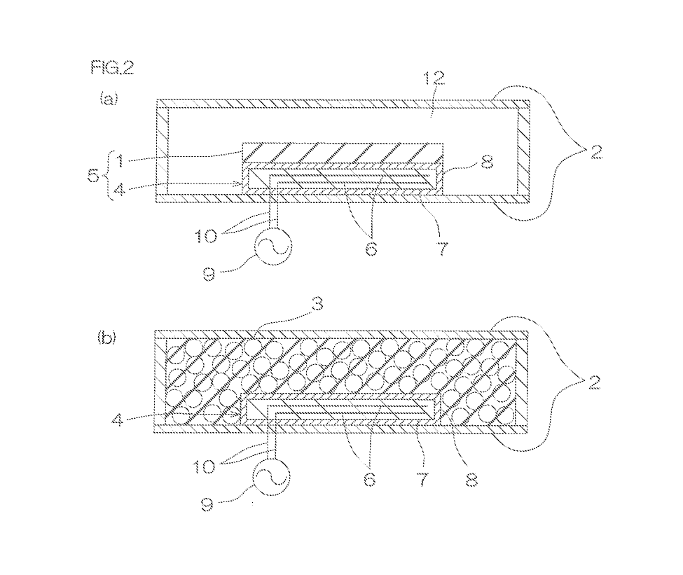

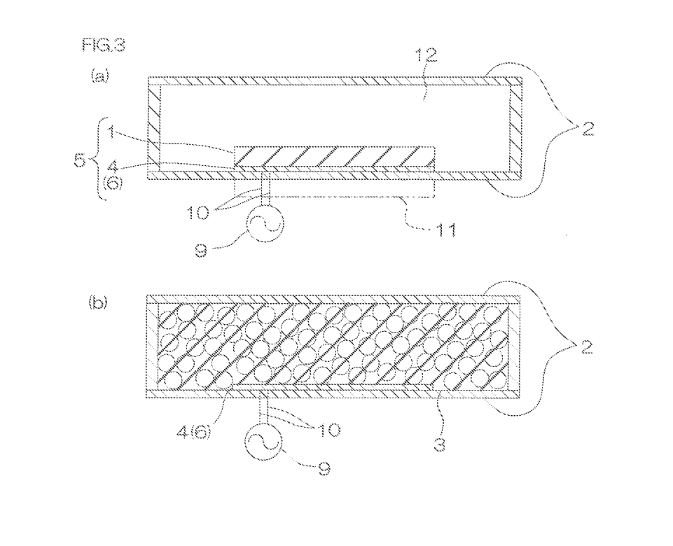

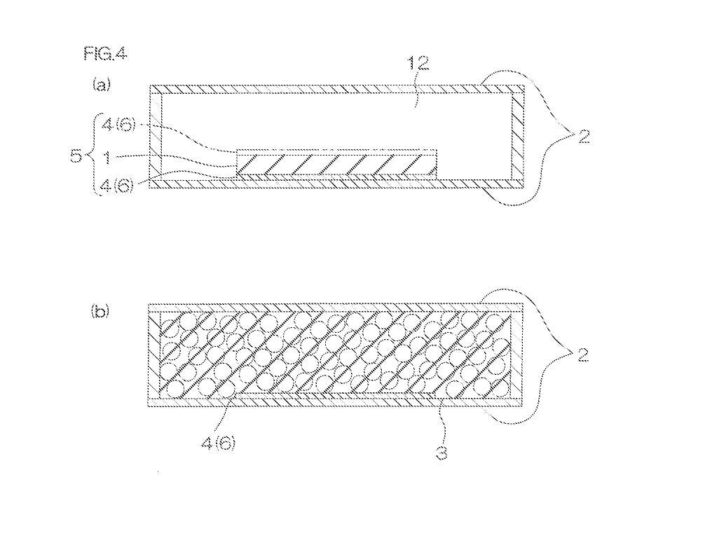

FIGS. 2 and 3 show sectional views for illustrating another embodiment (an embodiment of allowing a heat generating member to generate heat by an electric conduction) of the producing method of the foamed material of the present invention. FIG. 4 shows sectional views for illustrating another embodiment (an embodiment of allowing the heat generating member to generate heat by microwave irradiation) of the producing method of the foamed material of the present invention.

In each figure to be described below, the same reference numerals are provided for members corresponding to each of those described above, and their detailed description is omitted.

In the embodiment in FIG. 1, only the thermally foamable resin sheet 1 is disposed in the internal space 12 of the hollow member 2 described above and they are allowed to foam by heating. Alternatively, for example, as shown in FIGS. 2 to 4, a thermally foamable laminate 5 including a heat generating member 4 and the thermally foamable resin sheet 1 laminated on the heat generating member 4 is disposed in the hollow space 12 of the hollow member 2 described above to allow the heat generating member 4 to generate heat, so that the thermally foamable resin sheet 1 can be allowed to foam by heating.

In FIGS. 2 to 4, the thermally foamable laminate 5 is formed into a sheet shape and includes the heat generating member 4 and the thermally foamable resin sheet 1 laminated so as to be in contact with the heat generating member 4.

The heat generating member 4 contains a heat generating portion 6 (not shown in FIG. 2) which generates heat by, for example, an electric conduction, microwave irradiation, electromagnetic induction, or the like.

When the heat generating member 4 contains the heat generating portion 6 which generates heat by the electric conduction, as shown in FIG. 2, for example, the heat generating member 4 includes the heat generating portion 6, an insulator 7 in which the heat generating portion 6 is embedded, and a metal exterior plate 8 which covers the insulator 7.

The heat generating portion 6 is, for example, formed of an electrically resistant material. A plurality of the heat generating portions 6 are formed into linear shapes. Each of the heat generating portions 6 is connected to an electric power supply 9 via wires 10 and generates heat by conducting electricity from the electric power supply 9 via the wires 10.

To be specific, examples of the electrically resistant material include nickel-chrome alloy (Nichrome), aluminum-iron alloy, and tungsten. Preferably, Nichrome is used.

The insulator 7 is formed into a sheet shape such that the heat generating portions 6 are embedded in the insulator 7. An example of an insulating material for forming the insulator 7 includes a ceramic material such as isinglass (mica). Preferably, isinglass is used.

The metal exterior plate 8 is formed so as to cover the surfaces of the insulator 7. Examples of a metal material for forming the metal exterior plate 8 include iron, stainless steel, and aluminum.

A commercially available product can be used as the heat generating member 4. An example thereof includes a heating device (trade name “Sakaguchi space heater”, manufactured by SAKAGUCHI E.H VOC CORP.).

The thickness of the heat generating member 4 is, for example, 1 to 10 mm.

The thermally foamable laminate 5 including the heat generating member 4 and the thermally foamable resin sheet 1 shown in FIG. 2 (a) is disposed in the hollow space 12 of the hollow member 2 so that the metal exterior plate 8 is adjacent to the hollow member 2. The electric power supply 9 is disposed in the outside of the above-described hollow member 2 and is connected to the heat generating portions 6 via the wires 10 which extend through the hollow member 2.

Next, when the electricity is conducted from the electric power supply 9 to the heat generating portions 6 via the wires 10, the heat generating portions 6 generate heat and subsequently, the heat is sequentially conducted to the insulator 7 and the metal exterior plate 8. And, the thermally foamable resin sheet 1 is heated via the metal exterior plate 8. Then, as shown in FIG. 2 (b), the foamed material 3 is formed and in this way, the internal space 12 of the hollow member 2 is filled in with the formed foamed material 3.

Electricity-conducting conditions are as follows: an electric voltage of, for example, 1 to 1000 V; an output power of, for example, 10 to 1000 W; and an electricity-conducting duration of, for example, 1 to 30 minutes. The flowing current may be either alternating current or direct current. Preferably, alternating current is used.

According to this method, the heat generating member 4 of the thermally foamable laminate 5 is allowed to generate heat to heat the thermally foamable resin sheet 1, so that the thermally foamable resin sheet 1 can be allowed to easily foam.

In addition, by being set to the above-described electricity-conducting conditions, the thermally foamable resin sheet 1 can be heated at the above-described low temperature (to be specific, 120° C. or less).

In the thermally foamable laminate 5 shown in FIG. 3, the heat generating member 4 is formed of only the heat generating portion 6.

The heat generating portion 6 is, for example, formed into a sheet shape and is formed of the same electrically resistant material as that in the description above. Preferably, the heat generating portion 6 is formed of Nichrome and tungsten.

The thickness of the heat generating portion 6 is, for example, 0.5 to 10 mm.

Then, the thermally foamable laminate 5 including the heat generating member 4 consisting of the heat generating portion 6 shown in FIG. 3 (a) and the thermally foamable resin sheet 1 is disposed in the hollow space 12 of the hollow member 2 so that the heat generating member 4 is adjacent to the hollow member 2.

Next, when the electricity is conducted from the electric power supply 9 to the heat generating portion 6 via the wires 10 in the same electricity-conducting conditions as that in the description above, the heat generating member 4 generates heat and the thermally foamable resin sheet 1 is heated. Then, as shown in FIG. 3 (b), the foamed material 3 is formed and in this way, the internal space 12 of the hollow member 2 is filled in with the formed foamed material 3.

According to this method, the heat generating member 4 of the thermally foamable laminate 5 is allowed to generate heat to heat the thermally foamable resin sheet 1, so that the thermally foamable resin sheet 1 can be allowed to easily foam.

Additionally, unlike in the case of the heat generating member 4 shown in FIG. 2, the heat generating member 4 shown in FIG. 3 is not required to include the insulator 7 and the metal exterior plate 8 in the heat generating member 4, so that the configuration thereof can be easily formed.

As shown by phantom lines in FIG. 3 (a), an electromagnetic induction heating device 11 can be provided instead of the electric power supply 9 and the wires 10.

That is, in FIG. 3 (a), the electromagnetic induction device 11 is disposed in the outside of the hollow member 2 and is disposed in opposed relation to the heat generating member 4 by sandwiching the hollow member 2 with the heat generating member 4. The electromagnetic induction heating device 11 allows the heat generating portion 6 to generate heat by the electromagnetic induction.

And, the heat generating portion 6 is subjected to the electromagnetic induction by the electromagnetic induction device 11, so that the heat generating portion 6 generates heat. In this way, the thermally foamable resin sheet 1 is heated. Then, as shown in FIG. 4 (b), the foamed material 3 is formed and in this way, the internal space 12 of the hollow member 2 is filled in with the formed foamed material 3.

Or, when the heat generating member 4 includes the heat generating portion 6 which generates heat by the microwave irradiation, as shown in FIG. 4, the heat generating member 4 is made of a microwave absorber which absorbs a microwave.

In FIG. 4, the microwave absorber is formed into a sheet shape and contains a microwave absorbing material. To be more specific, the microwave absorber includes a substrate and a microwave absorbing layer which covers the substrate.

The substrate is formed into a sheet shape. As a material for forming the substrate, for example, the above-described resin is used, preferably, the thermoplastic resin is used, or more preferably, PET is used.

The thickness of the substrate is, for example, 0.1 to 10 mm.

The microwave absorbing layer is made of the microwave absorbing material and is formed on the surface (one surface and/or the other surface) of the substrate. Examples of the microwave absorbing material include a conducting substance, a magnetic substance, and a polar resin. Preferably, a conducting substance is used.

Examples of the conducting substance include a metal, a carbon substance, and a polymer substance.

Examples of the metal include copper, silver, gold, iron, aluminum, chromium, nickel, tin, zinc, indium, or alloys thereof (brass, stainless steel, and the like).

Examples of the carbon substance include carbon black such as acethylene black, oil-furnace black, thermal black, and channel black and graphite such as natural graphite and synthetic graphite (artificial graphite).

An example of the polymer substance includes a conjugated conducting polymer such as polyacetylene, polyaniline, polypyrrole, polyparaphenylene, and polyparaphenylene sulfide.

Of the above-described conducting substances, preferably, a metal substance is used, or more preferably, aluminum is used.

Examples of the magnetic substance include a ferromagnetic substance and a diamagnetic substance. Preferably, a ferromagnetic substance is used, or more preferably, soft magnetic ferrite (soft ferrite) and soft magnetic irons are used.

The polar resin is a resin having a polar group such as a cyano group, a hydroxyl group, a carboxyl group, an amino group, an epoxy group, and chlorine.

Examples of the polar resin include a polar rubber, a thermoplastic polar resin (excluding a rubber), and a thermosetting polar resin. Preferably, a polar rubber is used, or to be more specific, a synthetic polar rubber such as an acrylonitrilebutadiene rubber (NBR) and a chloroprene rubber (CR).

When the microwave absorbing layer is formed of a conducting substance (preferably, a metal), the microwave absorbing layer is formed on the surface of the substrate by, for example, a vacuum deposition method such as a sputtering.

The thickness of the microwave absorbing layer is, for example, 0.1 to 100 μm.

In order to allow the thermally foamable resin sheet 1 to foam, in the thermally foamable laminate 5 including the heat generating member 4 made of the microwave absorber and the thermally foamable resin sheet 1 laminated on the heat generating member 4, the thermally foamable laminate 5 is disposed in the hollow space 12 of the hollow member 2 so that the heat generating member 4 is in contact with the hollow member 2 and then, they are put in a known microwave generating device. Then, the microwave is applied to the thermally foamable laminate 5 and the hollow member 2, or preferably to the heat generating member 4.

Irradiation conditions of the microwave are as follows: a wavelength of the microwave of, for example, 100 μm to 1 m; a frequency of, for example, 300 MHz to 3 THz; an irradiation output power of the microwave of, for example, 100 to 2000 W; and an irradiation duration of, for example, 0.2 to 30 minutes.

In this way, the microwave absorbing layer of the microwave absorber absorbs the microwave to generate heat. The heat is conducted to the thermally foamable resin sheet 1 to heat the thermally foamable resin sheet 1 and the thermally foamable resin sheet 1 foams.

Unlike in the case of the heat generating member 4 shown in FIGS. 2 and 3, the heat generating member 4 shown in FIG. 4 is not required to be connected to the electric power supply 9 and the wires 10, so that the configuration thereof can be further easily formed.

In addition, by being set to the above-described irradiation conditions of the microwave, the thermally foamable resin sheet 1 can be heated at the above-described low temperature (to be specific, 120° C. or less).

In the above-described embodiment in FIG. 4, as shown by solid lines, the thermally foamable resin sheet 1 is laminated on one surface of the heat generating member 4. Alternatively, for example, as shown by the phantom lines in FIG. 4, the heat generating member 4 can further be laminated on the other surface of the thermally foamable resin sheet 1.

That is, the heat generating member 4 can be laminated on both surfaces of one surface and the other surface of the thermally foamable resin sheet 1.

### EXAMPLES

While the present invention will be described hereinafter in further detail with reference to Examples and Comparative Examples, the present invention is not limited to these Examples and Comparative Examples.

Examples 1, 8 to 19 and Comparative Examples 1 and 2

Components each were kneaded in accordance with the mixing formulation of Table 1 with a mixing roll at 50° C. with the number of revolutions of 10 min⁻¹ for 10 minutes to prepare kneaded products (thermally foamable resin compositions). Thereafter, the prepared kneaded products were pressed at 50° C. at a pressure of 50 kg/cm² for 5 minutes to form thermally foamable resin sheets each having a thickness of 5 mm. In Example 1, a thermally foamable resin sheet having a thickness of 2 mm was also formed.

### Examples 3 to 7

Thermally foamable resin sheets each having a thickness of 5 mm were formed in the same manner as in Example 1, except that the kneading temperature and the pressing temperature were changed to normal temperature (20° C.).

(Evaluation)

(1) Mooney Viscosity

In the preparation of the kneaded products described above, for the kneaded products obtained by kneading the components other than a thermally expandable capsule, OBSH, and foamable resin particles without blending any of these therein, the Mooney viscosity (ML₁₊₄, 100° C.) was measured. The results are shown in Table 1.

(2) Density and Foaming Ratio

The thermally foamable resin sheets each having a thickness of 5 mm obtained by the description above were stamped out into circular shapes each having a diameter of 19 mm to produce samples. Thereafter, the produced samples were put in an oven at 100° C. to be heated for 15 minutes, so that the samples were allowed to foam and then, foamed materials were obtained.

Each of the density before and after foaming (samples before foaming and foamed materials after foaming) was measured in conformity with JIS Z8807 to calculate the foaming ratio therefrom. The results are shown in Table 1.

(3) Foamable Filling Property

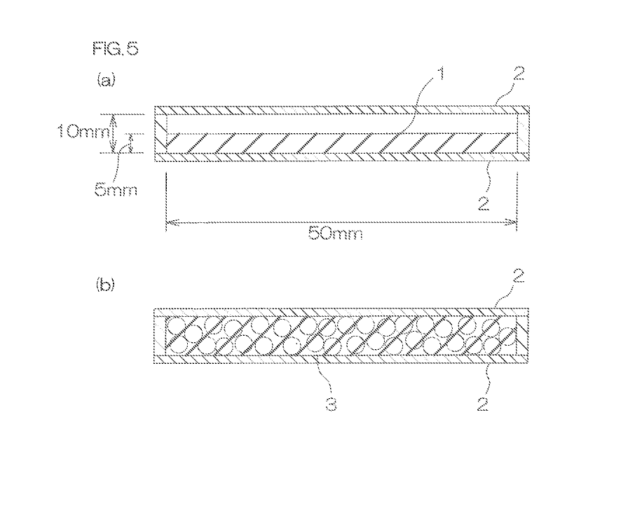

The thermally foamable resin sheets each having a thickness of 5 mm obtained by the description above were cut out into the size of 50 mm in length and 20 mm in width to produce samples (1). Thereafter, the produced samples (1) were placed in the center of the upper surface of test steel plate (2) at the lower side between the test steel plates (2) each having a size (length of 50 mm and width of 25 mm) shown in FIG. 5 (a).

Thereafter, the samples (1) obtained in Examples 1 to 18 and Comparative Examples 1 and 2 were put in an oven at 100° C. The sample (1) obtained in Example 19 was put in an oven at 120° C. Each of the samples (1) was heated for 15 minutes, so that as shown in FIG. 5 (b), the samples (1) were allowed to foam to obtain foamed materials (3).

The foamable filling properties of the foamed materials (3) between the test steel plates (2) were evaluated visually with the following criteria. The results are shown in Table 1.

(Evaluation Criteria)

Good: Foamable filling properties were good.

Bad: A space (a non-filled portion) was observed and the foamable filling properties were slightly defective.

(4) Foamability by Electric Conduction and Microwave Irradiation

A. Foaming by Electric Conduction

A-1. Heating Device

A heat generating member (a heating device: trade name “Sakaguchi space heater”, capacity of 60 W, manufactured by SAKAGUCHI E.H VOC CORP.), which included a heat generating portion formed into a linear shape made of Nichrome, an insulator in which the heat generating portion was embedded and formed into a sheet shape made of mica, and a metal exterior plate covering the insulator, was prepared. The thickness of the heat generating member was 4 mm and the size thereof was 50 mm×50 mm.

Separately, the thermally foamable resin sheet having a thickness of 2 mm in Example 1 obtained by the description above was cut into a size of 50 mm×50 mm to produce a sample.

Next, the above-described sample was laminated on the heat generating member to produce a thermally foamable laminate (ref: FIG. 2 (a)).

Then, the electricity was conducted from an electric power supply to the heat generating portion via wires at an electric voltage of 50 V for 1 minute to allow the heat generating portion to generate heat.

In this way, the thermally foamable resin sheet was allowed to foam to obtain a foamed material (ref: FIG. 2 (b)).

A-2. Nichrome Foil

A heat generating member (Nichrome foil), which included a heat generating portion formed into a sheet shape made of Nichrome, was prepared. The thickness of the heat generating member was 2 mm and the size thereof was 50 mm×50 mm.

Separately, a sample (50 mm×50 mm×2 mm) produced from Example 1 obtained by the description above was prepared.

Next, the above-described sample was laminated on the heat generating member to produce a thermally foamable laminate (ref: FIG. 3 (a)).

Then, the electricity was conducted from an electric power supply to the heat generating portion via wires at an electric voltage of 50 V for 1 minute to allow the heat generating portion to generate heat.

In this way, the thermally foamable resin sheet was allowed to foam to obtain a foamed material (ref: FIG. 3 (b)).

B. Foaming by Microwave Irradiation

A heat generating member, which was made of a microwave absorber in which a microwave absorbing layer was formed on the surface of a substrate made of PET by an aluminum deposition, was prepared. The thickness of the heat generating member was 6 um and the size thereof was 50 mm×50 mm.

Separately, a sample (50 mm×50 mm×2 mm) produced from Example 1 obtained by the description above was prepared.

Next, the above-described sample was laminated on the heat generating member to produce a thermally foamable laminate (ref: FIG. 4 (a)).

Then, the thermally foamable laminate was put in a microwave generating device (trade name: CRE173-5, manufactured by Convesta) and a microwave (a wavelength of 12.2 cm, a frequency of 2.45 GHz) was applied to the sample with an output power of 260 W for 1 minute.

In this way, the thermally foamable resin sheet was allowed to foam to obtain a foamed material (ref: FIG. 4 (b)).

TABLE 1

| | | | | Examples and Comparative Examples | | | | | | | | | | | |
|---|---|---|---|---|---|---|---|---|---|---|---|---|---|---|---|
| | | | | Ex. | Ex. | Ex. | Ex. | Ex. | Ex. | Ex. | Ex. | Ex. | Ex. | Ex. | Ex. |
| | | | | 1 | 2 | 3 | 4 | 5 | 6 | 7 | 8 | 9 | 10 | 11 | 12 |
| Mixing | Resin | Rubber | Poly- | 100 | 65 | 35 | — | — | — | — | — | — | — | 50 | 50 |
| Formu- | Compo- | | isobutylene | | | | | | | | | | | | |
| lation | sition | | Rubber*1 | | | | | | | | | | | | |
| of Ther- | | | Poly- | — | 35 | 65 | 100 | — | — | — | — | — | — | 50 | 50 |
| mally | | | isobutylene | | | | | | | | | | | | |
| Foam- | | | Rubber*2 | | | | | | | | | | | | |
| able | | | Silicone | — | — | — | — | 100 | — | — | — | — | — | — | — |
| Resin | | | Rubber*3 | | | | | | | | | | | | |
| Compo- | | | Silicone | — | — | — | — | — | 100 | — | — | — | — | — | — |
| sition | | | Rubber*4 | | | | | | | | | | | | |
| (Parts | | | EPDM*5 | — | — | — | — | — | — | — | 100 | — | — | — | — |
| by | | | EPDM*6 | — | — | — | — | — | — | — | — | 100 | — | — | — |
| Weight) | | | EPDM*7 | — | — | — | — | — | — | — | — | — | 100 | — | — |
| | | Thermo- | Epoxy | — | — | — | — | — | — | 40 | — | — | — | — | — |
| | | setting | Resin*8 | | | | | | | | | | | | |
| | | Resin | Epoxy | — | — | — | — | — | — | 30 | — | — | — | — | — |
| | | | Resin*9 | | | | | | | | | | | | |
| | | Filler | Talc | — | — | — | — | — | — | 30 | — | — | — | — | — |
| | | | Barite | — | — | — | — | — | — | — | — | — | — | — | — |
| | | Thermally | Matsumoto | — | — | — | — | — | — | — | — | — | — | — | — |
| | | Expand- | Microsphere | | | | | | | | | | | | |
| | | able | F-36*10 | | | | | | | | | | | | |
| | | Capsule | | | | | | | | | | | | | |
| | | OBSH | Neocellborn | — | — | — | — | — | — | — | — | — | — | — | — |
| | | | #1000M*11 | | | | | | | | | | | | |

| | | | | | | | | | | | | | | |
|---|---|---|---|---|---|---|---|---|---|---|---|---|---|---|
| | Thermally Foamable | Foamable | 70 | 70 | 70 | 70 | 85 | 130 | 70 | 70 | 70 | 70 | 70 | — |
| | Resin Particle | Bead*12 | | | | | | | | | | | | |
| | | Foamable | — | — | — | — | — | — | — | — | — | — | — | 70 |
| | | Bead | | | | | | | | | | | | |
| | | K-BS*13 | | | | | | | | | | | | |
| | | Foamable | — | — | — | — | — | — | — | — | — | — | — | — |
| | | Bead | | | | | | | | | | | | |
| | | HS*14 | | | | | | | | | | | | |
| | | Foamable | — | — | — | — | — | — | — | — | — | — | — | — |
| | | Bead | | | | | | | | | | | | |
| | | HCH2*15 | | | | | | | | | | | | |
| | | Foamable | — | — | — | — | — | — | — | — | — | — | — | — |
| | | Bead | | | | | | | | | | | | |
| | | HLA★16 | | | | | | | | | | | | |
| Evalu- | Mooney Viscosity*17 | Before | 58 | 26 | 7 | 2 | 27 | 25 | 18 | 85 | 45 | 38 | 9 | 9 |
| ation | (ML₁₊₄, 100° C.) | Foaming | | | | | | | | | | | | |
| | Density*18 | | 0.96 | 0.85 | 0.78 | 0.8 | 0.96 | 0.99 | 1.2 | 0.81 | 0.84 | 0.72 | 0.88 | 0.87 |
| | (g/cm³) | After | 0.16 | 0.17 | 0.13 | 0.16 | 0.06 | 0.09 | 0.12 | 0.09 | 0.14 | 0.12 | 0.13 | 0.15 |
| | Foaming Ratio*19 | Foaming*20 | 6 | 5 | 6 | 5 | 16 | 11 | 10 | 9 | 6 | 6 | 7 | 6 |
| | (times) | | | | | | | | | | | | | |
| | Foamable Filling | | Good | Good | Good | Good | Good | Good | Good | Good | Good | Good | Good | Good |
| | Property | | | | | | | | | | | | | |

| | | | | Examples and Comparative Examples | | | | | | | | |
|---|---|---|---|---|---|---|---|---|---|---|---|---|
| | | | | Ex. | Ex. | Ex. | Ex. | Ex. | Ex. | Ex. | Comp | Comp |
| | | | | 13 | 14 | 15 | 16 | 17 | 18 | 19 | Ex. 1 | Ex. 2 |
| Mixing | Resin | Rubber | Poly- | 50 | 50 | 50 | 50 | 50 | 4 | 50 | — | — |
| Formu- | Compo- | | isobutylene | | | | | | | | | |
| lation | sition | | Rubber*1 | | | | | | | | | |
| of Ther- | | | Poly- | 50 | 50 | 50 | 50 | 50 | 4 | 50 | — | — |
| mally | | | isobutylene | | | | | | | | | |
| Foam- | | | Rubber*2 | | | | | | | | | |
| able | | | Silicone | — | — | — | — | — | — | — | — | — |
| Resin | | | Rubber*3 | | | | | | | | | |
| Compo- | | | Silicone | — | — | — | — | — | — | — | — | — |
| sition | | | Rubber*4 | | | | | | | | | |
| (Parts | | | EPDM*5 | — | — | — | — | — | — | — | 100 | 100 |
| by | | | EPDM*6 | — | — | — | — | — | — | — | — | — |
| Weight) | | | EPDM*7 | — | — | — | — | — | — | — | — | — |
| | | Thermo- | Epoxy | — | — | — | — | — | — | — | — | — |
| | | setting | Resin*8 | | | | | | | | | |
| | | Resin | Epoxy | — | — | — | — | — | — | — | — | — |
| | | | Resin*9 | | | | | | | | | |
| | | Filler | Talc | — | — | — | — | — | — | — | — | — |
| | | | Barite | — | — | — | — | — | 92 | — | — | — |
| | | Thermally | Matsumoto | — | — | — | — | — | — | — | — | 20 |
| | | Expand- | Microsphere | | | | | | | | | |
| | | able | F-36*10 | | | | | | | | | |
| | | Capsule | | | | | | | | | | |
| | | OBSH | Neocellborn | — | — | — | — | — | — | — | 20 | — |
| | | | #1000M*11 | | | | | | | | | |

| | | | | | | | | | | | |
|---|---|---|---|---|---|---|---|---|---|---|---|
| | Thermally Foamable | Foamable | — | — | 10 | 40 | 300 | 15 | — | — | — |
| | Resin Particle | Bead*12 | | | | | | | | | |
| | | Foamable | — | — | — | — | — | — | — | — | — |
| | | Bead | | | | | | | | | |
| | | K-BS*13 | | | | | | | | | |
| | | Foamable | 70 | — | — | — | — | — | — | — | — |
| | | Bead | | | | | | | | | |
| | | HS*14 | | | | | | | | | |
| | | Foamable | — | 70 | — | — | — | — | — | — | — |
| | | Bead | | | | | | | | | |
| | | HCH2*15 | | | | | | | | | |
| | | Foamable | — | — | — | — | — | — | 70 | — | — |
| | | Bead | | | | | | | | | |
| | | HLA★16 | | | | | | | | | |
| Evalu- | Mooney Viscosity*17 | Before | 9 | 9 | 9 | 9 | 9 | 12 | 9 | 7 | 58 |
| ation | (ML₁₊₄, 100° C.) | Foaming | | | | | | | | | |
| | Density*18 | | 1.18 | 0.87 | 0.9 | 0.88 | 0.76 | 2.6 | 0.86 | 0.86 | 0.81 |
| | (g/cm³) | After | 0.43 | 0.11 | 0.45 | 0.22 | 0.042 | 1.3 | 0.11 | 0.86 | 0.81 |
| | Foaming Ratio*19 | Foaming*20 | 3 | 8 | 2 | 4 | 18 | 2 | 8 | 1 | 1 |
| | (times) | | | | | | | | | | |
| | Foamable Filling | | Good | Good | Good | Good | Good | Good | Good | Bad | Bad |
| | Property | | | | | | | | | | |

In Table 1, values in the row of “Mixing Formulation of Thermally Foamable Resin Composition” represent the number of parts by weight of the components.

In Table 1, for the components, the compounds and evaluation with “*” are given in details below.

Polyisobutylene Rubber *1: Oppanol B50, a weight average molecular weight (GPC: calibrated with standard polystyrene) of 340000, a density of 0.92 g/cm³, manufactured by BASF

Polyisobutylene Rubber *2: Oppanol B12, a weight average molecular weight (GPC: calibrated with standard polystyrene) of 51000, a density of 0.92 g/cm³, manufactured by BASF

Silicone Rubber *3: KE-550-U, a density of 1.21 g/cm³, manufactured by Shin-Etsu Chemical Co., Ltd.

Silicone Rubber *4: KE-951-U, a density of 1.14 g/cm³, manufactured by Shin-Etsu Chemical Co., Ltd.

EPDM *5: EPT9090M, a diene content of 14.2%, manufactured by Mitsui Chemicals, Inc.

EPDM *6: EPT4045, a diene content of 8.0%, manufactured by Mitsui Chemicals, Inc.

EPDM *7: EPT1045, a diene content of 5.0%, manufactured by Mitsui Chemicals, Inc.

Epoxy Resin *8: EPIKOTE 834, bisphenol A epoxy resin, an epoxy equivalent of 230 to 270, a density of 1.18 g/cm³, manufactured by Japan Epoxy Resins Co., Ltd.

Epoxy Resin *9: PKHM-301, bisphenol A epoxy resin, glass transition temperature of 45° C., a weight average molecular weight of 39000, manufactured by InChem Corporation

Matsumoto Microsphere F-36 *10: trade name, thermally expandable capsule, foaming starting temperature of 75 to 85° C., maximum expansion temperature of 120 to 130° C., an average particle size of 10 to 16 μm, manufactured by Matsumoto Yushi-Seiyaku Co., Ltd

Neocellborn 1000M *11: trade name, 4,4′-oxybis(benzenesulphonyl hydrazide), foaming starting temperature of 160° C., an average particle size of 4 μm, an amount of generated gas of 125 ml/g (160° C.), manufactured by EIWA CHEMICAL IND. CO., LTD.

Foamable Bead *12: foamable polystyrene bead (foamable resin particles), glass transition temperature of resin of 85° C., thermal expansion starting temperature of 70° C., an average particle size of 0.46 mm, a density (before thermal expansion) of 1.00 g/cm³, expansion ratio of 45 times (100° C.)

Foamable bead KANEPEARL K-BS *13: foamable polystyrene bead (thermally foamable resin particles), an average particle size of 0.6 mm, manufactured by Kaneka Corporation

Foamable bead KANEPEARL SR *14: foamable polystyrene bead (thermally foamable resin particles), an average particle size of 0.19 mm, manufactured by Kaneka Corporation

Foamable bead HCH2 *15: trade name, Eslen Beads HCH₂, foamable polystyrene bead (thermally foamable resin parcitles), an average particle size of 1.13 mm, manufactured by SEKISUI PLASTICS CO., LTD.

Foamable bead HLA3000 *16: trade name, HEATPOR GR HLA3000, a foamable acrylonitrile-styrene copolymer bead, foamability (thermally foamable resin parcitles), an average particle size of 1.13 mm, manufactured by JSP.

Mooney Viscosity *17: Mooney viscosity at 100° C., measured with automatic Mooney viscometer “AM-1” (manufactured by Toyo Seiki Seisaku-Sho, LTD.)

Density *18: measured with in conformity with JIS Z8807

Foaming Ratio *19: volume expansion ratio=density of sample before foaming/density of foamed material after foaming

After foaming *20: after foam formation

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICABILITY

The thermally foamable resin composition, the thermally foamable resin sheet, the thermally foamable laminate, and the foamed material of the present invention can be used as a filler, which fills in space between various members or the internal space of a hollow member, of industrial products in various industrial fields.

1. A thermally foamable resin composition comprising:
foamable resin panicles and a resin composition, wherein
each of the foamable resin particles contains a solid resin, and a thermally expandable substance contained in the solid resin.

2. The thermally foamable resin composition according to claim 1, wherein
the thermally foamable resin composition can foam by heating at 120° C. or less.

3. The thermally foamable resin composition, according to claim 1, wherein
the resin composition contains at least one selected from tire group consisting of a rubber, a thermoplastic resin, and a thermosetting resin.

4. The thermally foamable resin composition according to claim 1, wherein
the density thereof after foaming is 0.02 to 1.5 g/cm³.

5. The thermally foamable resin composition according to claim 1, wherein
the boiling point of the thermally expandable substance is −160 to 120° C.

6. The thermally foamable resin composition according to claim 1, wherein
the foamable resin particles are obtained by polymerizing a monomer of the resin in the presence of the thermally expandable substance.

7. The thermally foamable resin composition according to claim 1, wherein
the resin is a polystyrene and/or a polystyrene copolymer.

8. The thermally foamable resin composition according to claim 1, wherein
the content ratio of the foamable resin panicles is 0.1 to 350 parts by weight with respect to 100 parts by weight of the resin composition.

9. A thermally foamable resin sheet formed from a thermally foamable resin composition into a slice shape, wherein
the thermally foamable resin composition comprises;
foamable resin particles and a resin composition, and
each of the foamable resin particles contains a solid resin and a thermally expandable substance contained in the solid resin.

10. A thermally foamable laminate comprising:
a heat generating member capable of generating heat and
a thermally foamable resin sheet laminated so as to be in contact with the heal generating member, wherein
the thermally foamable resin sheet is formed from a thermally foamable resin composition into a sheet shape, and
the thermally foamable resin composition comprises:
foamable resin particles and a resin composition, and
each of the foamable resin particles contains a solid resin and a thermally expandable substance contained in the solid resin.

11. The thermally foamable laminate according to claim 10, wherein
the heat generating member generates heat by an electric conduction.

12. The thermally foamable laminate according to claim 10, wherein
the heat generating member generates heat by microwave irradiation.

13. A foamed material obtained by heating a thermally foamable resin composition to foam, wherein
the thermally foamable resin composition comprises:
foamable resin particles and a resin composition, and
each of the foamable resin particles contains a solid resin and a thermally expandable substance contained in the solid resin.

14. A foamed material obtained by heating a thermally foamable resin sheet to foam, wherein
the thermally foamable resin sheet is formed from a thermally foamable resin composition into a sheet shape, and
the thermally foamable resin composition comprises:
foamable resin particles and a resin composition, and
each of the foamable resin particles contains a solid resin and a thermally expandable substance contained in the solid resin.

15. A foamed material obtained by allowing a heat generating member of a thermally foamable laminate to generate heat so as to heat a thermally foamable resin sheet to foam, wherein
the thermally foamable laminate comprises:
the heat generating member capable of generating heat and
the thermally foamable resin sheet laminated so as to be in contact with the heat generating member, and
the thermally foamable resin sheet is formed from a thermally foamable resin composition, into a sheet shape, and
the thermally foamable resin composition comprises:
foamable resin particles and a resin composition, and
each of the foamable resin particles contains a solid resin and a thermally expandable substance contained in the solid resin.

16. A foamed material obtained by conducting electricity through a heat generating member of a thermally foamable laminate to allow the heat generating member to generate heat so as to heat a thermally foamable sheet to foam, wherein
the thermally foamable laminate comprises:
the heat generating member capable of generating heat and
the thermally foamable resin sheet laminated so as to be in contact with the heat generating member, and
the thermally foamable resin sheet is formed from a thermally foamable resin composition into a sheet shape, and
the thermally foamable resin composition comprises:
foamable resin particles and a resin composition, and
each of the foamable resin particles contains a solid resin and a thermally expandable substance contained in the solid resin.

17. A foamed material obtained by applying a microwave to a heat generating member of a thermally foamable laminate to allow the heat generating member to generate heat so as to heal a thermally foamable sheet to foam, wherein
the foamable laminate comprises:
the heat generating member capable of generating heat and
the thermally foamable resin sheet laminated so as to be in contact with the heat generating member, and
the thermally foamable resin sheet is formed from a thermally foamable resin composition into a sheet shape, and
the thermally foamable resin composition comprises:
foamable resin particles and a resin composition, and
each of the foamable resin particles contains a solid resin and a thermally expandable substance contained in the solid resin.

18. A method for producing a foamed material comprising:
heating a thermally foamable resin composition to foam, wherein
the thermally foamable resin composition comprises:
foamable resin particles and a resin composition, and
each of the foamable resin particles contains a solid resin and a thermally expandable substance contained in the solid resin.

19. A method for producing a foamed material comprising:
heating a thermally foamable resin sheet to foam, wherein
the thermally foamable resin sheet is formed from a thermally foamable resin composition, into a sheet shape, and
the thermally foamable resin composition comprises;
foamable resin particles and a resin composition, and
each of the foamable resin particles contains a solid resin and a thermally expandable substance contained in the solid resin.

20. A method for producing a foamed material comprising:
allowing a heat generating member of a thermally foamable laminate to generate heat so as to heat a thermally foamable resin sheet to foam, wherein
the thermally foamable laminate comprises:
the heat generating member capable of generating heat and
the thermally foamable resin sheet laminated so as to be in contact with the heat generating member, and
the thermally foamable resin sheet is formed from a thermally foamable resin composition into a sheet shape, and
the thermally foamable resin composition comprises:
foamable resin particles and a resin composition, and
each of the foamable resin particles contains a solid resin and a thermally expandable substance contained in the solid resin.

21. A method for producing a foamed material comprising:
conducting electricity through a heat generating member of a thermally foamable laminate to allow the heat generating member to generate heat so as to heat a thermally foamable resin sheet to foam, wherein
the thermally foamable laminate comprises:
the heat generating member capable of generating heat and
the thermally foamable resin sheet laminated so as to be in contact with the heat generating member, and
the thermally foamable resin sheet is formed from a thermally foamable resin composition into a sheet shape, and
the thermally foamable resin composition comprises:
foamable resin particles and a resin composition, and
each, of the foamable resin particles contains a solid resin and a thermally expandable substance contained in the solid resin.

22. A method for producing a foamed material comprising:
applying a microwave to a heat generating member of a thermally foamable laminate to allow the heat generating member to generate heat so as to heat a thermally foamable resin sheet to foam, wherein
the thermally foamable laminate comprises:
the heat generating member capable of generating heat and
the thermally foamable resin sheet laminated so as to be in contact with the heat generating member, and
the thermally foamable resin sheet is formed from a thermally foamable resin composition into a sheet shape, and
the thermally foamable resin composition comprises:
foamable resin particles and a resin composition, and
each of the foamable resin particles contains a solid resin and a thermally expandable substance contained in the solid resin.

23. The method for producing the foamed material according to claim 18, wherein
the thermally foamable resin composition is heated at a temperature of 120° C. or less.

24. The method for producing the foamed material according to claim 19, wherein
the thermally foamable resin sheet is heated at a temperature of 120° C. or less.

25. The method for producing the foamed material according to claim 20, wherein the thermally foamable resin sheet is heated at a temperature of 120° C. or less.
